(19) United States
(12) Patent Application Publication
(10) Pub. No.: US 2009/0146098 A1
(43) Pub. Date: Jun. 11, 2009

(54) POWDER EXTINGUISHING AGENT AND METHOD FOR MANUFACTURING THE SAME

(75) Inventors: Guang-Liang Sheu, Tu-Cheng (TW); Li-Qing Zhang, Shenzhen City (CN)

Correspondence Address: PCE INDUSTRY, INC.;ATT. Steven Reiss, 458 E. LAMBERT ROAD, FULLERTON, CA, 92835, US

(73) Assignees: Fu Zhun Precision Industry (Shen Zhen) Co., Ltd., Shenzhen City (CN); Foxconn Technology Co., Ltd., Tu-Cheng (TW)

(21) Appl. No.: 12/186,528

(22) Filed: Aug. 6, 2008

(30) Foreign Application Priority Data
Dec. 10, 2007 (CN) 200710202946.6

(51) Int. Cl. A62D 1/00; B01J 2/00

(52) U.S. Cl. 252/5; 264/140

(57) ABSTRACT

The present invention relates to a powder extinguishing agent used for extinguishing fires of burning light metals. The powder extinguishing agent includes: potassium chloride in an amount from 40% to 50% by weight, sodium chloride in an amount from 45% to 55% by weight, and calcium fluoride in an amount from 2% to 8% by weight. The present invention also relates to a method for manufacturing the powder extinguishing agent.

### BACKGROUND OF THE INVENTION

1. Field of the Invention

The present invention relates generally to powder extinguishing agents and, more particularly, to a powder extinguishing agent used for extinguishing fires of burning light metals.

2. Discussion of the Related Art

Light metals, such as magnesium alloy, aluminum alloy, and titanium alloy, are good candidates for use in various portable electronic devices, such as MP3 players, personal digital assistances (PDAs), and mobile phones, because of their high mechanical strength and light weight. However, some light metals are combustible in air, because of their chemical characteristics. In a melting or casting process, the light metals can easily catch fire because of high temperatures of the process. It is dangerous when the light metals catch fire because they burn violently and sometimes even cause serious explosion.

A conventional means for extinguishing fires of burning light metals is to sprinkle dry sand on the burning light metals, thus the fires may be suppressed via isolation of air. However, the use of the dry sand is not advantageous in practice because the dry sand is difficult to diffuse and completely cover the burning light metal. In addition, because of the large particle size of the dry sand, air would permeate into gaps between the particles of the dry sand and contact with the light metal, thus the light metal may burn up again. Therefore, the effect of using the dry sand is not satisfied.

What is needed, therefore, is a new powder extinguishing agent that overcomes the above mentioned disadvantages.

### SUMMARY

In one aspect, a powder extinguishing agent includes: potassium chloride in an amount from 40% to 50% by weight, sodium chloride in an amount from 45% to 55% by weight, and calcium fluoride in an amount from 2% to 8% by weight.

In another aspect, a method for manufacturing the powder extinguishing agent includes following steps. Firstly, a crucible is heated to about 250° C. to 300° C., then 40% to 50% by weight of the potassium chloride and 45% to 55% by weight of the sodium chloride are added in the crucible. Secondly, an admixture of the potassium chloride and the sodium chloride is heated until the admixture is partially melted, then 2% to 8% by weight of the calcium fluoride is added in the crucible. Thirdly, the crucible is heated to about 750° C. to 800° C., and an admixture of the potassium chloride, the sodium chloride and the calcium fluoride is completely melted. Then the melted admixture is stirred uniformly and casted in a mold. After the mold is cooled, the melted admixture is solidified as a block. Fourthly, the block is crushed into powder via a ball mill, thus the powder extinguishing agent is achieved.

Other advantages and novel features will become more apparent from the following detailed description.

### DETAILED DESCRIPTION OF THE EMBODIMENTS

Reference will now be made to describe preferred embodiments of the present powder extinguishing agents, in detail. The present powder extinguishing agents are used for extinguishing fires of burning light metals.

A powder extinguishing agent according to a first preferred embodiment includes: potassium chloride in an amount 45% by weight, sodium chloride in an amount 50% by weight, and calcium fluoride in an amount 5% by weight.

The potassium chloride and the sodium chloride form a binary eutectic mixture, thus the powder extinguishing agent has a low melting point, that is in the range from about 400° C. to about 500° C. Therefore, when the powder extinguishing agent is sprinkled on burning light metals, the powder extinguishing agent would be melted quickly, then the melted powder extinguishing agent flows on the burning light metals and completely covers the burning light metals, thus the fires may be suppressed due to isolation of oxygen in the air. The burning light metals are covered by the melted powder extinguishing agent, thus there is no gap for air permeating into the melted powder extinguishing agent. Therefore, the fires can be completely extinguished via sufficiently suffocating effect of the melted powder extinguishing agent. At the same time, the sodium chloride may be decomposed into sodium hydroxide in high temperature, and this chemical reaction would absorb a lot of heat energy, thus to promote fire-extinguishing further.

After the powder extinguishing agent is melted, the melted potassium chloride has a low surface tension and a low viscosity, so that the surface tension and the viscosity of the melted powder extinguishing agent is decreased via the melted potassium chloride. Therefore, the melted powder extinguishing agent has a good fluidity for covering the burning light metals in a short time.

The component of the powder extinguishing agent, the potassium chloride, the sodium chloride and the calcium fluoride can not react with the light metals. Thus, after the burning light metals are extinguished, the light metals can be recovered and re-utilized. The calcium fluoride can be used to promote the refining ability of the melted powder extinguishing agent, thus allowing the melted powder extinguishing agent to more easily separate from the melted light metals.

Other preferred embodiments of the powder extinguishing agent are shown in Table 1.

TABLE 1

| | potassium | sodium | calcium |
|---|---|---|---|
| | chloride | chloride | fluoride |
| Embodiments | weight, % | weight, % | weight, % |
| Second | 40 | 55 | 5 |
| Third | 50 | 45 | 5 |
| Fourth | 48 | 50 | 2 |
| Fifth | 42 | 50 | 8 |
| Sixth | 41 | 53 | 6 |
| Seventh | 45 | 48 | 7 |
| eighth | 42 | 55 | 3 |

When using the powder extinguishing agent according to these preferred embodiments, the powder extinguishing agent can be sprinkled on the burning light metals via using the high pressure gas to spread the power. The gas is selected from argon gas, helium gas and other inert gas.

A method for manufacturing the powder extinguishing agent includes following steps.

Firstly, a crucible is heated to about 250° C. to 300° C., then 40% to 50% by weight of the potassium chloride and 45% to 55% by weight of the sodium chloride are added in the crucible. The temperature of the crucible for adding the potassium chloride and the sodium chloride is, preferably, from 275° C. to 285° C.

Secondly, an admixture of the potassium chloride and the sodium chloride is heated until the admixture is partially melted, then 2% to 8% by weight of the calcium fluoride is added in the crucible.

Thirdly, the crucible is heated to about 750° C. to 800° C., and an admixture of the potassium chloride, the sodium chloride and the calcium fluoride is completely melted. Then the melted admixture is stirred uniformly and casted in a mold. After the mold is cooled, the melted admixture is solidified as a block. The temperature of the crucible for stirring and casting the melted admixture is, preferably, from 775° C. to 785° C.

Fourthly, the block is crushed into powder by a ball mill, thus the powder extinguishing agent is achieved.

It should be understood that, the block can be crushed into powder by other machines, such as raymond mill, jet mill and so on.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A powder extinguishing agent comprising: potassium chloride in an amount from 40% to 50% by weight, sodium chloride in an amount from 45% to 55% by weight, and calcium fluoride in an amount from 2% to 8% by weight.

2. The powder extinguishing agent as claimed in claim 1, wherein the potassium chloride is in an amount 45% by weight, sodium chloride is in an amount 50% by weight, and calcium fluoride is in an amount 5% by weight.

3. The powder extinguishing agent as claimed in claim 1, wherein the potassium chloride is in an amount 40% by weight, sodium chloride is in an amount 55% by weight, and calcium fluoride is in an amount 5% by weight.

4. The powder extinguishing agent as claimed in claim 1, wherein the potassium chloride is in an amount 50% by weight, sodium chloride is in an amount 45% by weight, and calcium fluoride is in an amount 5% by weight.

5. The powder extinguishing agent as claimed in claim 1, wherein the potassium chloride is in an amount 48% by weight, sodium chloride is in an amount 50% by weight, and calcium fluoride is in an amount 2% by weight.

6. The powder extinguishing agent as claimed in claim 1, wherein the potassium chloride is in an amount 42% by weight, sodium chloride is in an amount 50% by weight, and calcium fluoride is in an amount 8% by weight.

7. The powder extinguishing agent as claimed in claim 1, wherein the potassium chloride is in an amount 41% by weight, sodium chloride is in an amount 53% by weight, and calcium fluoride is in an amount 6% by weight.

8. The powder extinguishing agent as claimed in claim 1, wherein the potassium chloride is in an amount 45% by weight, sodium chloride is in an amount 48% by weight, and calcium fluoride is in an amount 7% by weight.

9. The powder extinguishing agent as claimed in claim 1, wherein the potassium chloride is in an amount 42% by weight, sodium chloride is in an amount 55% by weight, and calcium fluoride is in an amount 3% by weight.

10. The powder extinguishing agent as claimed in claim 1, wherein the melting point of the powder extinguishing agent is in the range from 400° C. to 500° C.

11. A method for manufacturing a powder extinguishing agent, comprising:
heating a crucible to about 250° C. to about 300° C., then adding 40% to 50% by weight of the potassium chloride and 45% to 55% by weight of the sodium chloride in the crucible;
heating an admixture of the potassium chloride and the sodium chloride until the admixture is partially melted, then adding 2% to 8% by weight of the calcium fluoride in the crucible;
heating the crucible to about 750° C. to about 800° C., and an admixture of the potassium chloride, the sodium chloride and the calcium fluoride is completely melted, then stirring the melted admixture and casting the melted admixture in a mold, after the mold is cooled, the melted admixture is solidified as a block; and
crushing the block into powder.

12. The method for manufacturing a powder extinguishing agent as claimed in claim 11, wherein the temperature of the crucible for adding the potassium chloride and the sodium chloride is in the range from 275° C. to 285° C.

13. The method for manufacturing a powder extinguishing agent as claimed in claim 11, wherein the temperature of the crucible for stirring and casting the melted admixture is in the range from 775° C. to 785° C.

14. The method for manufacturing a powder extinguishing agent as claimed in claim 11, wherein the block is crushed into powder by a ball mill.

15. The method for manufacturing a powder extinguishing agent as claimed in claim 11, wherein the block is crushed into powder by a raymond mill or a jet mill.
